(19) United States
(12) Patent Application Publication
(10) Pub. No.: US 2002/0064175 A1
(43) Pub. Date: May 30, 2002

(54) Method and circuit for aligning data flows in time division frames

(75) Inventors: Giovanni Traverso, Rovagnate (IT); Marco Novati, Merate (IT); Luca Razzetti, Sesto San Giovanni (IT)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/884,226

(22) Filed: Jun. 20, 2001

(30) Foreign Application Priority Data
Jun. 27, 2000 (IT) TO2000A000633

(51) Int. Cl. H04B 7/212

(52) U.S. Cl. 370/442; 370/389

(57) ABSTRACT

Method for aligning data flows in time division frames, providing for measuring the phase of said input data flow with respect to the phase of a reference signal, for controlling, depending on the measured phase, the delay time introduced by a delay line in said input data flow. According to the invention, it is provided to measure the phase of the input data flow in a time interval substantially corresponding to the transit time of a sure data sequence containing a logic transition, said sure data sequence being comprised in said input data flow.

### INCORPORATION BY REFERENCE OF PRIORITY DOCUMENT

This application is based on and claims the benefit of Italian Patent Application No. TO2000A000633 filed on Jun. 27, 2000, which is incorporated by reference herein.

### BACKGROUND OF THE INVENTION

1. Field of the Invention

The present invention relates to a method for aligning data flows in time division frames.

Carrying out of digital communication systems often has to face a condition, wherein input data to a telecommunication network node have a determined nominal frequency, but are affected by phase modulations with respect to a reference signal, such as a clock signal, said modulations being due to various reasons, such as thermal drifts and/or other propagation problems on the transmitting means.

As a result, said phase modulations, which may arise at high frequency (jitter) or at low frequency (wander), generate reception bit errors.

Therefore, in order to avoid recognition errors, the phase of said input data has to be aligned, e.g. inside the node, to the phase of a reference clock signal having the same instantaneous frequency. A correct phase alignment is most significant in the case of time division frames.

2. Description of the Prior Art

In order to obtain the above phase alignment, delay locked loops, also known as DLL, are commonly employed.

Also DLL loops are based on feedback loops and essentially comprise a delay line, receiving at its input the signal to be aligned, i.e. in the specific case the data signal, and producing several output signals, which are delayed with respect to the signal to be aligned. A phase comparator will check the phase difference of the input data signal with respect to the reference signal, i.e. by way of example the clock signal, and consequently instruct a control logic contolling the delay time introduced by the delay line, selecting one of the various taps in the delay line.

Alternatively, DLL circuits may also be used in those systems where the delay of the single delay element of the line is feedback controlled, obtaining a behaviour similar to the Phase Locked Loops.

One problem associated to these circuits is that they are particularly expensive from a power consumption viewpoint, since they operate continuously during the whole data flow transit. The problem related to power consumption is particularly critical with the increasing input data frequency and number of channels for each device, such as in the case of a switch matrix device.

### SUMMARY OF THE INVENTION

It is the object of the present invention to solve the above drawbacks and provide a method for aligning data flows in time division frames, having a more efficient and improved performance with respect to existing solutions.

In this frame, it is the main object of the present invention to provide a method for aligning data flows in time division frames, which is suitable for use at high frequencies and having low energy consumption.

In order to achieve such aims, it is the object of the present invention to provide a method for aligning data flows in time division frames and/or a circuit for aligning high frequency data in time division frames, and/or a delay line, incorporating the features of the annexed claims, which form an integral part of the description herein.

### BRIEF DESCRIPTION OF THE DRAWINGS

Further objects, features and advantages of the present invention will become apparent from the following detailed description and annexed drawings, which are supplied by way of non limiting example, wherein:

FIG. 1 shows a basic block diagram of a telecommunication network receiver implementing a method for aligning data flows in time division frames, according to the present invention;

FIG. 2 shows a basic diagram of a phase alignment circuit implementing the method for aligning data flows in time division frames, according to the present invention.

### BEST MODE FOR CARRYING OUT THE INVENTION

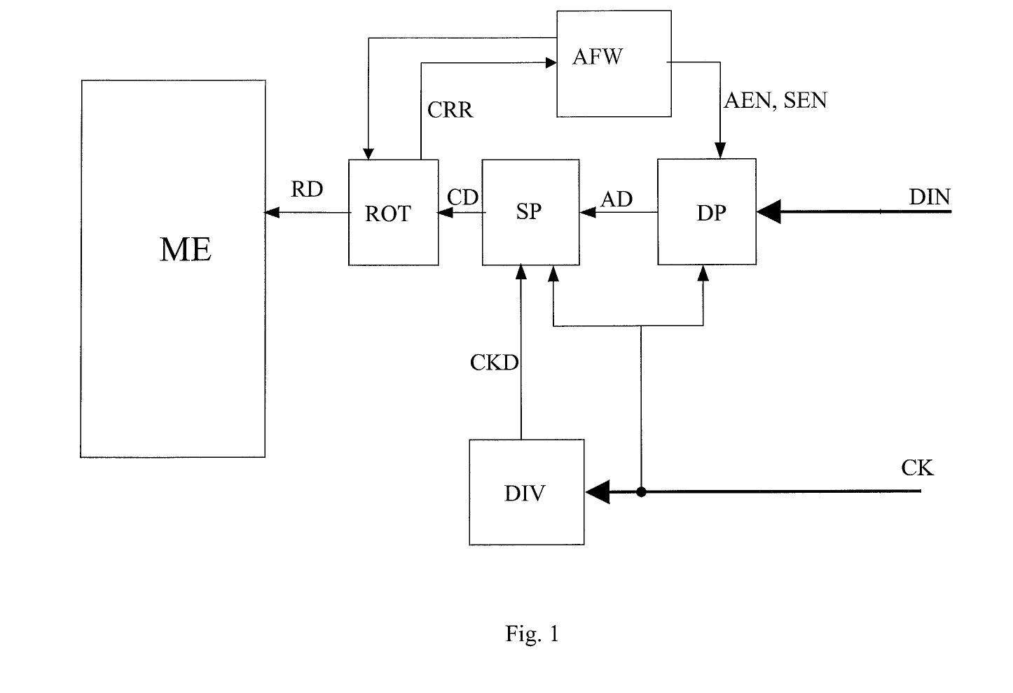

FIG. 1 is representing a block diagram of the receiver of a “backpanel” like interface of a switching matrix in a synchronous telecommunication network, such as SDH (Synchronous Data Hierarchy); it is understood that the reference to SDH in the following has not to be interpreted in a limiting sense, as the invention can be applicable to SONET as well.

FIG. 1 illustrates an input data flow DIN, which consists of an SDH frame flow at a nominal frequency of 622.08 MHz. Said data flow DIN is initially handled by a phase aligning circuit DP, which receives at another input the clock signal CK at 622.08 MHz, generated outside the interface of the switching matrix.

An aligned data flow AD output from the phase aligning circuit DP is now phase aligned with the clock signal CK and consequently sent to a serial-parallel circuit SP, which will perform a serial-to-parallel data conversion. The serial-parallel circuit SP is driven by a divided frequency clock signal CKD, generated by a special divider circuit DIV, which divides the clock signal CK by 8, originating a frequency of 77 MHz for the divided frequency clock signal CKD.

Therefore, the serial-parallel circuit SP produces a converted data flow CD, which is finally appropriately rotated by means of a rotator circuit ROT, controlled by a circuit for recognition of the alignment word AFW, usually placed on SDH frame receiving circuits, in order to align the bit flow correctly, identifying in SDH frames appropriate alignment words AW provided right to this purpose by the standards, i.e. recognition of information start point in the frame. The circuit for recognition of the alignment word AFW causes the byte to rotate inside the rotator circuit ROT for recovering the correct byte frame alignment, producing a rotated data flow output RD.

In the case of an input data flow DIN consisting of an STM-4 like frame, the alignment word AW matches the first 24 byte of the frame and consists of 12 byte representing the exadecimal value F6, followed by 12 byte representing the hexadecimal value 28. Since the hexadecimal value F6 matches a binary 11110110 and the hexadecimal value 28 matches a binary 00101000, the bit sequences 101 and 010, herein underlined inside the binary values for better highlighting them, well represent identifiable transitions in said byte.

The rotator circuit ROT sends to the circuit for recognition of the alignment word AFW an information on the correction CRR performed by said rotator circuit ROT, i.e. by how many bytes the word AW has been rotated to recover frame alignment. Since the byte structure F6 and 28 forming the alignment word AW is known, said information on the correction CRR also contains information about the transitions position and allows generating a synchronism, represented by a second enable signal SEN on the clock signal CK in correspondence with the sure transition on the input data flow DIN.

Since the information on the correction CRR comes from the rotator circuit ROT driven by the divided frequency clock signal CKD, it is clocked at 77 MHz frequency, but quite advantageously it also contains information about the bit of the alignment word AW, in spite of this alignment word AW being clocked at 622.08 MHz frequency.

Said rotated data flow RD is then received by an elastic memory ME, operating as a buffer, wherefrom it goes further to the remaining interface circuits.

In FIG. 1 it should be noticed how according to a significant feature of the present invention, the circuit for recognition of the alignment word AFW also controls the phase aligning circuit DP. A portion of the logics required for phase alignment consists advantageously of the logic already provided for the circuit for recognition of the alignment word AFW, which performs frame alignment.

According to the present invention, the presence is used of a predetermined structure in time division frames, particularly in SDH frames, and also, specifically, the presence is used in said frames of the alignment word AW, which forms a sure data sequence containing a logic transition for measuring the phase displacement of the input data flow DIN with respect to the clock signal CK, just for a time interval matching the passage of said alignment word AW, maintaining said phase aligning circuit DP not in operation for the remaining passage of the frames contained in the data flow DIN.

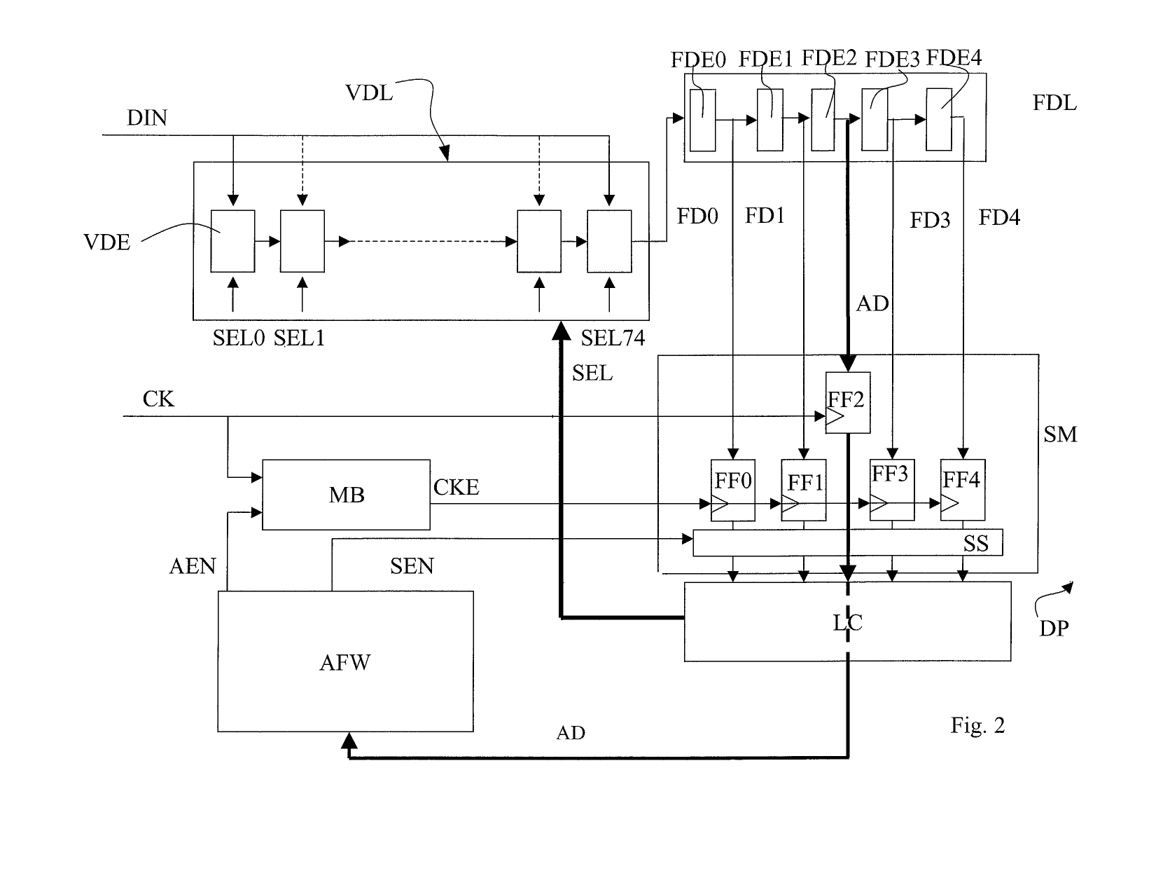

FIG. 2 is representing a block diagram of the phase aligning circuit DP.

The input data flow DIN is sent to a variable delay line VDL pertaining to the phase aligning circuit DP, which counts 75 delay elements VDE, from VDE0 to VDE74, arranged in a ladder structure. Each delay element VDE is controlled by a respective selection signal SEL0 . . . SEL74, whose effects on the elements VDE of the delay line VDL will be further explained. Downstream the variable delay line VDL, the input data flow reaches a fixed delay line FDL, which consists of five delay elements FDE with a fixed delay, i.e. from FDE0 to FDE4. Downstream of the element FDE2, which is the center element of the fixed delay line FDL, the aligned data flow AD is fetched and sent to the serial-parallel circuit SP, as illustrated in FIG. 1. Therefore, this aligned data flow AD is sent to a flip-flop FF2, pertaining to a set of five flip-flops FF0 . . . FF4, which form a monitoring line of a sampling and monitoring stage SM, together with a subsequent sampling stage SS consisting of two further five flip-flop stages masked by the second enable signal SEN, which enables them for operation, i.e. to let data advance only during the transit of the transition contained in the alignment word AW. Flip-flop FF2 is driven by the clock signal CK for governing the aligned data flow AD advance to the serial-parallel circuit SP, as well as to the circuit for recognition of the alignment word AFW.

Moreover, the clock signal CK is sent to a masking block MB, whose operation is controlled by the circuit for recognition of the alignment word AFW by means of an enable signal AEN for generating a masked clock signal CKE, i.e. a clock signal entirely similar to the clock signal CK for its frequency, but active only when the time window matches the passage of the alignment word AFW, i.e. being masked for the remaining frame transit time. This masked clock signal CKE drives the remaining flip-flops FF0, FF1, FF3, FF4 of the sampling and monitoring stage SM.

Downstream of each delay element FDE0, FDE1, FDE3, FDE4 of the fixed delay line FDL a phase shifted data flow FD0, FD1, FD3, FD4 is fetched and sent to the relevant flip-flop of the sampling and monitoring stage SM. From the flip-flops FF0, FF1, FF3 and FF4, the phase-shifted data flows FD0, FD1, FD3, FD4 will advance to a logic control circuit LC, along with the aligned data flow AD.

The logic control circuit LC—based on the phase-shifted data flows FD0, FD1, FD3, FD4 and aligned data flow AD—is apt to supply the selection signals SEL0 . . . SEL74 for the variable delay line VDL.

The aligned data flow AD is also transmitted to the circuit for recognition of the alignment word AFW, in order to identify the alignment word AW.

The phase aligning circuit DP operates as follows:

in stable conditions, i.e. without having to adjust the phase, the input data flow DIN goes through all elements VDE from a i-th delay element VDEi to VDE74, i.e. introducing a constant delay. This is obtained by the control logic LC placing the i-th selection signal SEL at logic level one and keeping all other selection signals SEL at logic level zero. In the practice, as it can be seen in FIG. 2, the input data DIN go through the whole delay elements cascade VDE of the delay line VDL in a serial manner, accumulating the delay introduced by each delay element on the serial path, and are additionally sent in parallel to each delay element VDE, in this case without delay. When the signal SEL is a logic zero, the delay element is passing the data flow DIN, which receives in series. When the signal SEL is a logic one, the matching delay element VDE is not passing, so that the input data flow DIN received in parallel will propagate. In other words, all delay elements VDE upstream of the i-th non passing element VDE are by-passed and the delay introduced at the end of the serial track will only depend on the delay elements downstream the i-th delay element VDE, i.e. exactly the sum of said delays.

In other words, each delay element VDEi behaves like a multiplexer, letting either the input data flow DIN pass through, provided the respective selection signal SELi is one, or data come from the previous delay element VDE i-1, provided its own selection signal SELi is zero.

Should the control logic circuit LC detect a phase shift between the input data flow DIN and clock signal CK, and therefore a phase adjustment of the input data flow DIN be required, this control logic LC will move the index i of the signal SELi forward or backward by 1, i.e. setting the delay element VDE at logic one, which is either previous or subsequent to the one currently maintained at logic one, decrementing or incrementing the aligned data signal phase AD by one delay time. In order to avoid possible glitch phenomena, both the delay element VDEi and the subsequent selected element are simultaneously at logic one for a clock period of the divided frequency clock signal CKD. Changing the values of selection signals SEL is only admitted outside the time window, wherein the alignment word AW passes to the circuit for recognition of the alignment word AFW. Thus, possibly irrelevant samples eventually available on the flip-flops FF0, FF1, FF3, FF4 while changing the selection signals SEL do not determine the decision of the subsequent selection signals values SEL, because the subsequent time window on the alignment word AW must be waited.

The sampling and monitoring stage SM, driven by the second enable signal SEN, will activate in correspondence of the transitions 010 and 101 in the phase shifted data flows FD0, FD1, FD3, FD4 and aligned data flow AD, for controlling the input data phase DIN.

The circuit for recognition of the alignment word AFW sends the enable signal AEN to the masking block MB when the alignment word AFW is passing through it. Therefore, the sampling and monitoring stage SM allows the phase shifted data flows FD0, FD1, FD3, FD4 and aligned data AD to go to the control logic circuit LC for the 24-byte duration only of the alignment word AFW. This occurs because the masked clock signal CKE driving the first flip-flop stage FF0, FF1, FF3, FF4 of the sampling and monitoring stage SM is active during that time interval only. The subsequent stages of the sampling and monitoring stage SM, driven by the second enable signal SEN, will perform the sampling only in correspondence with the transitions 101 and 010 in the alignment word AW.

When the value sampled through the sampling and monitoring stage SM of the phase shifted data flows FD0, FD1, FD3, FD4 differs from the value of the aligned data flow AD, the control logic circuit LC operates a change of the selection signals SEL to modify the delay introduced by the variable delay line VDL. The criteria adopted by the control logic LC is as follows: it is enough, in at least one of the fetched 24 samples matching the 24 bytes that form the alignment word AW, that at least one of the phase shifted data flows FD0 and FD1, or one of the phase shifted data flows FD3 and FD4, differ from the aligned data flow AD, in order to decide whether incrementing or decrementing the index i of the selection signals SEL by one. In the above case, a change of said index is allowed for each frame, but said index may also be changed depending on the transit of a larger number of frames. Equally, the number of delay elements FDE of the fixed delay line FDL may be other than five. This odd number changes depending on the technologic spread.

From the above description the features of the present invention are clear, and also its advantages are clear.

Advantageously, the method for aligning data flows in time division frames according to the present invention allows to obtain a data phase alignment circuit operating efficiently at high frequency with an extremely reduced power consumption, since the phase alignment circuit will only operate during the passage of the frame alignment word, i.e. for the passage of a few bytes only, whereas said phase alignment circuit is deactivated during the passage of the remaining frame. Advantageously, the phase alignment method of data flows in time division frames according to the present invention further utilizes digital delay lines, which ensure a high phase resolution and are driven by a control logic employing standard circuit elements.

Moreover, a delay line architecture is also advantageously described, which provides for changing the delay introduced without changing the delay of the individual cell and without fetching the data from the various delay line taps at the same time. This is an advantageous feature, since it avoids placing a complex multiplexer downstream of the delay line for the purpose of selecting the tap involved.

It is obvious that many changes are possible for the man skilled in the art to the phase alignment of data flows in time division frames and/or to the phase alignment of an input data flow in a time division frame described above by way of example, without departing from the novelty principles of the innovative idea, and it is also clear that in practical actuation of the invention the components may often differ in form and size from the ones described and be replaced with technical equivalent elements.

In particular, the forms of the data frames to which the method according to the present invention is applied to may differ and also the alignment sequences utilized for phase control may change and be differently arranged inside the frame.

What is claimed is:

1. A method for aligning data flows in time division frames, that provides for measuring the phase of said input data flow with respect to the phase of a reference signal, for controlling the delay time introduced by a delay line in said input data flow depending on the measured phase, wherein the phase of the input data flow is measured in a time interval substantially corresponding to the transit time of a sure data sequence containing a logic transition, said sure data sequence being comprised in said input data flow.

2. A method for aligning data flows in time division frames, according to claim 1, wherein the flow of said sure data sequence containing a logic transition is detected, and consequently an enable signal activating a phase sampling operation is generated.

3. A method for aligning data flows in time division frames, according to claim 2, wherein, by said enable signal, a masked reference signal is obtained from the reference signal, said masked reference signal being active only during the passage of the sure data sequence containing a logic transition.

4. A method for aligning data flows in time division frames, according to claim 1, wherein a further delay line is provided with a fixed delay for producing a plurality of delayed phases from the input data flow.

5. A method for aligning data flows in time division frames, according to claim 4, wherein said masked reference signal is used for controlling execution of the sampling operation of said plurality of delayed phases.

6. A method for aligning data flows in time division frames, according to claim 5, wherein a second enable signal is obtained indicating the presence of the logic transition in the sure data sequence containing a logic transition, and said second enable signal is used for activating the sampling operation of said plurality of delayed phases.

7. A method for aligning data flows in time division frames, according to claim 6, wherein said second enable signal is obtained from a correction signal deriving from an alignment operation of the input data flow.

8. A method for aligning data flows in time division frames, according to claim 2, wherein the result of said sampling operation is supplied to a control logic, which generates selection signals apt for controlling the delay time of the delay line, depending on the said result of the sampling operation.

9. A method for aligning data flows in time division frames, according to claim 8, wherein the control logic decides for incrementing or decrementing by one the index i of the selection signals, provided at least one of the first two delayed phases or one of the last two delayed phases in at least one of the values sampled during the whole transit of the sure sequence, differs from an aligned data flow.

10. A method for aligning data flows in time division frames, according to claim 1, wherein said sure data sequence is a frame alignment word and that the time division frames forming the input data flow are either SDH or Sonet frames.

11. A phase alignment circuit of an input data flow in a time division frame, comprising a phase equalizer apt to equalize the phase of a reference signal with the phase of the input data flow and drive, through appropriate selection signals, a variable delay line operating on the input data flow, wherein a detector is provided for the transit of a sure data sequence containing a logic transition comprised in the input data flow.

12. A phase alignment circuit of an input data flow in a time division frame, according to claim 11, wherein said detector controls the operation of the phase equalizer through an enable signal.

13. A phase alignment circuit of an input data flow in a time division frame, according to claim 12, wherein a logic masker is provided apt to obtain a masked clock signal from the combination of the enable signal and reference signal.

14. A phase alignment circuit of an input data flow in a time division frame, according to claim 11, wherein, downstream of the variable delay line, a further delay line is provided pertaining to the phase equalizer, which produces a plurality of delayed phases from the input data flow.

15. A phase alignment circuit of an input data flow in a time division frame, according to claim 14, wherein the phase equalizer comprises a sampler of said plurality of delayed phases, which employ the masked clock signal as a clock signal.

16. A phase alignment circuit of an input data flow in a time division frame, according to claim 15, wherein said sampler of said delayed phase plurality receives at least a second enable signal generated by the detector, which indicates the transit of the transition in the sure data sequence.

17. A phase alignment circuit of an input data flow in a time division frame, according to claim 15, wherein the phase equalizer comprises a control logic arranged downstream the sampler, for receiving the sampled values of the plurality of delayed phases and emitting the selection signals depending on them.

18. A phase alignment circuit of an input data flow in a time division frame, according to claim 10, wherein the variable delay line is obtained through a ladder of delay elements.

19. A delay line comprising a plurality of delay elements and a data flow to be delayed passing in series through said plurality of delay elements, wherein one or more of the delay elements also receive the input data flow in parallel, and that said delay elements are apt to select which of the data flows received in series or in parallel should be transmitted.
